(19) United States
(12) Patent Application Publication
(10) Pub. No.: US 2010/0006306 A1
(43) Pub. Date: Jan. 14, 2010

(54) Fire Protection System for a Dwelling

(76) Inventors: Odette Pezeshkian, Glendale, CA (US); Hasmik Nazarian, Glendale, CA (US)

Correspondence Address: LAW OFFICE OF JERRY D. HAYNES , P.A, P.O. Box 350392, Fort Lauderdale, FL, 33335, US

(21) Appl. No.: 12/169,855

(22) Filed: Jul. 9, 2008

(51) Int. Cl. A62C 3/00

(52) U.S. Cl. 169/54

(57) ABSTRACT

Disclosed is a fire protection system for a dwelling or a building. The fire protection system is adapted to protect the dwelling or building from fire, such as a forest fire. The fire protection system comprises a cover member composed of a fire resistant material, a first fastening mechanism and an operating mechanism. The cover member is adapted to assume a folded position and an unfolded position, and is capable of enclosing the dwelling when assuming the unfolded position. The first fastening mechanism is configured on the cover member and is adapted to retain the cover member in the unfolded position thereof. The operating mechanism is configured on a portion of the dwelling or building to enable the cover member to assume the folded position and the unfolded position.

### FIELD OF THE INVENTION

The present invention relates generally to a safety system for a dwelling, and, more particularly, to a fire protection system for protecting a dwelling from fire.

### BACKGROUND OF THE INVENTION

Dwellings situated in rural areas, particularly, dwellings that are situated nearby a forest, are vulnerable to forest fires. Specifically, every year, a large number of people lose their valuable possessions to such forest fires. A forest fire spreads very rapidly and uncontrollably in an affected area. Due to the rapid spreading of the forest fire in the affected area, people residing in dwellings of that area may not be able to protect their dwellings from being ruined by the fire. Moreover, people are unable to shift their valuable possessions from their dwellings to a safe place since they may be required to vacate their dwellings in a hurry, leaving behind their valuable possessions in the dwellings.

People may utilize traditional fire fighting means, such as water jet cannons or fire extinguishers, to suppress the forest fire. However, such traditional fire fighting means are not efficient enough to suppress a rapidly spreading forest fire. Moreover, large numbers fire fighters using such fire fighting means may be required to suppress the rapidly spreading fire, thereby increasing a financial and human cost associated with fire fighting.

Accordingly, there exists a need for a fire protection system for protecting a dwelling from fire, such as a forest fire, in an efficient and a cost effective manner.

### SUMMARY OF THE INVENTION

In view of the foregoing disadvantages inherent in the prior art, the general purpose of the present invention is to provide a fire protection system configured to include all the advantages of the prior art, and to overcome the drawbacks inherent therein.

Accordingly, an object of the present invention is to provide a fire protection system for a dwelling adapted to protect the dwelling from fire, such as forest fire, in an efficient and a cost effective manner.

In light of the above object the present invention, a fire protection system for a dwelling is disclosed. The fire protection system comprises a cover member, a first fastening mechanism and an operating mechanism. The cover member is composed of a fire resistant material. Further, the cover member is adapted to assume a folded position and an unfolded position. Moreover, the cover member is capable of enclosing the dwelling in the unfolded position. The first fastening mechanism is configured on the cover member and is adapted to retain the cover member in the unfolded position. The operating mechanism is configured to enable the cover member to assume the folded position and the unfolded position.

This together with other aspects of the present invention, along with the various features of novelty that characterize the present invention, is pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, in which:

FIG. 1 illustrates a perspective view of a fire protection system enclosing a dwelling, in accordance with an exemplary embodiment of the present invention; and

FIG. 2 illustrates a perspective view of a cover member of the fire protection system of FIG. 1 in a folded position, in accordance with an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in implementation thereof. It should be emphasized, however, that the present invention is not limited to a fire protection system for a dwelling, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a fire protection system for protecting a dwelling from fire. More specifically, for protecting a dwelling, which is situated nearby a forest, from catching forest fire. The term ‘dwelling’ used herein refers to a place of residence, to a building or to a structure that is intended for human or animal habitation and/or the storage of inanimate items. The fire protection system of the present invention protects the dwelling from such forest fire, thereby enabling people to protect their valuable possessions from any damage that may be caused by the forest fire. Although the present invention is described with reference to protecting dwellings in a forest area, it should be understood that the present inventions may also be utilized for protecting dwellings situated in the countryside, towns, cities and the like.

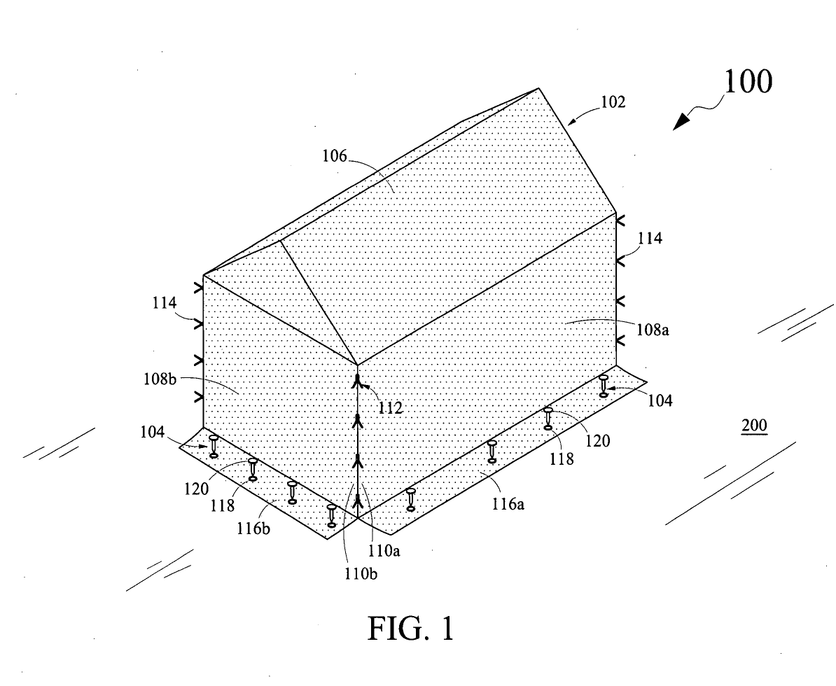

Referring now to FIG. 1, a perspective view of a fire protection system 100 enclosing a dwelling is illustrated, in accordance with an exemplary embodiment of the present invention. The fire protection system 100 includes a cover member 102, a first fastening mechanism 104, and an operating mechanism (not shown). The cover member 102 is composed of a fire-resistant material and is capable of assuming a folded position and an unfolded position. The first fastening mechanism 104 is configured on the cover member 102 and is capable of retaining the cover member 102 in the unfolded position. The operating mechanism is configured to enable the cover member 102 to assume the folded position and the unfolded position.

Further, the term “unfolded position”, as used herein, refers to an arrangement of the cover member 102 on the dwelling in a manner to cover the dwelling from all sides for enabling protection thereof from forest fire. More specifically, the cover member 102 is capable of enclosing a roof and sidewalls of the dwelling in the unfolded position. As shown in FIG. 1, the cover member 102 is in the unfolded position to enclose the dwelling to configure a fire protective covering over the dwelling. It should be understood that the cover member 102 in FIG. 1 is depicted to assume the unfolded position while enclosing the dwelling therebetween, and accordingly the dwelling is not shown in the FIG. 1.

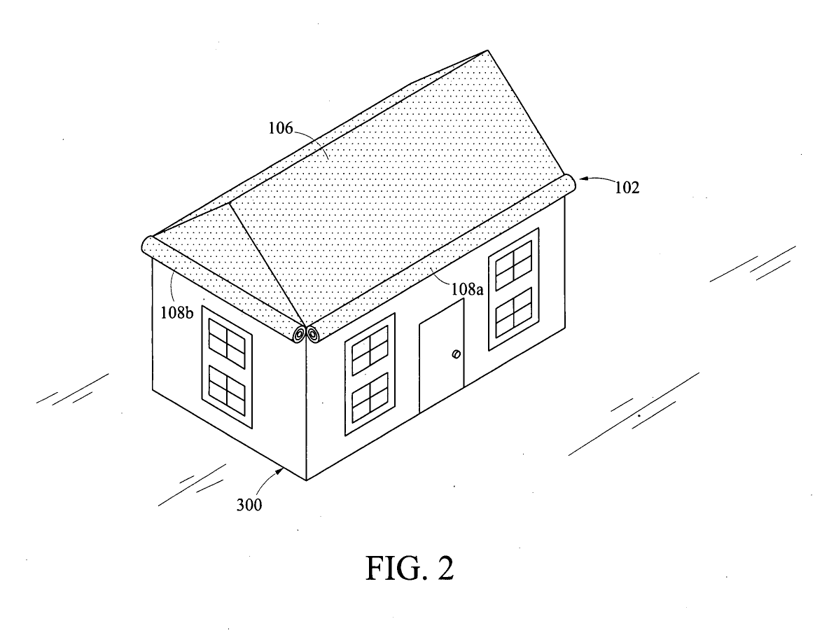

Furthermore, the term “folded position”, as used herein, refers to an arrangement of the cover member 102 when the cover member 102 is at least partially removed from the dwelling, thereby exposing certain portion of the dwelling, such as the side walls. The folded position of the cover member 102 will be explained in conjunction with FIG. 2.

As explained herein, the cover member 102 is capable of enclosing the dwelling when the cover member 102 assumes the unfolded position. In an embodiment of the present invention, the cover member 102 includes a plurality of cover portions capable of enclosing various portions, such as the roof and the sidewalls, of the dwelling. More specifically, the cover member 102 may include a central cover portion 106, and a plurality of side cover portions, such as a side cover portion 108a and a side cover portion 108b. However, it will be evident to a person skilled in the art that the cover member 102 may further include other side cover portions (not shown), similar to the side cover portions 108a and 108b, for enclosing other two sidewalls of the dwelling. The side cover portions 108a and 108b along with the other side cover portions are hereinafter collectively referred to as “side cover portions 108”. The side cover portions 108 extend from a periphery of the central cover portion 106.

The central cover portion 106 is adapted to be received on the roof of the dwelling and the side cover portions 108 are adapted to be received on the sidewalls of the dwelling. In an embodiment of the present invention, the central cover portion 106 of the cover member 102 may include a plurality of portions, seamed together in a manner such that the central cover portion 106 is capable of being received on the roof of the dwelling. Accordingly, the central cover portion 106 may enable in supporting the side cover portions 108 along the sidewalls of the dwelling.

As explained herein, the cover member 102 is composed of the fire-resistant material. More specifically, the central cover portion 106 and the side cover portions 108 are composed of the fire resistant material. Accordingly, the cover member 102 is capable of protecting the dwelling from forest fire upon enclosing the dwelling from all sides when assuming the unfolded position. In an embodiment of the present invention, the cover member 102 may be composed of a fiberglass fabric material.

Moreover, once the cover member 102 assumes the unfolded position, adjacently positioned side cover portions of the side cover portions 108 may be coupled to each other for enclosing the dwelling therebetween. For example, as shown in FIG. 1, in the unfolded position of the cover member 102, a lateral peripheral edge portion 110a of the side cover portion 108a may overlap with a lateral peripheral edge portion 110b of the adjacent side cover portion 108b. The overlapping lateral peripheral edge portions 110a and 110b may be coupled to each other by utilizing a second fastening mechanism 112. Similarly, lateral peripheral edge portions of other adjacently positioned side cover portions of the cover member 102 may be coupled together. More specifically, the second fastening mechanism 112 is adapted to couple adjacently positioned side cover portions of the side cover portions 108 when the cover member 102 assumes the unfolded position for enclosing the dwelling therebetween. Moreover, the second fastening mechanism 112 enables the side cover portions 108 to be securely received on the sidewalls of the dwelling, thereby preventing the side cover portions 108 to be displaced from the sidewalls of the dwelling.

In an embodiment of the present invention, the second fastening mechanism 112 may include a clamp arrangement for coupling the overlapping lateral peripheral edge portions of the adjacently positioned side cover portions of the side cover portions 108. For example, as shown in FIG. 1, the clamp arrangement may include a plurality of clamps, such as clamps 114, coupling the lateral peripheral edge portion 110a of the side cover portion 108a with the lateral peripheral edge portion 110b of the side cover portion 108b. Similarly, remaining lateral peripheral edge portions of the side cover portions 108 may be coupled by the clamps 114, thereby enabling the side cover portions 108, to enclose the dwelling therebetween. However, it will be apparent to person skilled in the art that, the second fastening mechanism 112 may include other known fastening means such as a hook and loop fastener arrangement, a zipper arrangement, a button and slot arrangement and a rope arrangement, configured on the lateral peripheral edge portions of each side cover portion of the side cover portions 108 for coupling the overlapping lateral peripheral edge portions thereof.

Further, each side cover portion of the side cover portions 108 includes a longitudinal peripheral edge portions. For example, the side cover portion 108a includes a longitudinal peripheral edge portion 116a. Similarly, the side cover portion 108b includes a longitudinal peripheral edge portion 116b. Further, as shown in FIG. 1, the longitudinal edge portions, such as longitudinal peripheral edge portions 116a and 116b, are configured with the first fastening mechanism 104 thereon. The first fastening mechanism 104 is adapted to retain the cover member 102 in the unfolded position by securing the longitudinal peripheral edge portions 116a and 116b of the side cover portions 108a and 180b to a surface 200, such as soil or concrete, on which the dwelling is supported.

In an embodiment of the present invention, the first fastening mechanism 104 may be a grommet and a peg arrangement, configured on the side cover portions 108. More specifically, a plurality of grommets 118 may be configured on the longitudinal peripheral edge portions 116a and 116b of the side cover portions 108. Further, the first fasting mechanism 104 includes a plurality of pegs 120 capable of being received through the plurality of grommets 118 into the surface 200 for securing the cover member 102 thereto. Accordingly, the side cover portions 108a and 108b of the cover member 102 remain firmly secured to the surface 200 while being received on the sidewalls of the dwelling, thereby retaining the cover member 102 in the unfolded position. In another embodiment of the present invention, the first fastening mechanism 104 may further include a plurality of weights to be configures on longitudinal peripheral edge portions, such as longitudinal peripheral edge portions 116a and 116b, of the side cover portions 108 for retaining the cover member 102 in the unfolded position.

As explained herein before, the cover member 102 is also capable of assuming the folded position. More specifically, the cover member 102 may assume the folded position when the fire protection system 100 is not in use. Referring to FIG. 2, a perspective view of the cover member 102 of the fire protection system of FIG. 1 in a folded position is illustrated, in accordance with an exemplary embodiment of the present invention. As shown in FIG. 2, the fire protection system 100 is configured at the roof of a dwelling 300. More specifically, the central cover portion 106 of the cover member 102 is received on the roof of the dwelling 300 for configuring the fire protection system 100 thereon.

Furthermore, as shown in FIG. 2, the side cover portions 108a and 108b of the cover member 102 are rolled and retained in the rolled position thereof for enabling the cover member 102 to assume the folded position. In an embodiment of the present invention, the central cover portion 106 may also be configured to be rolled. Further, in another embodiment of the present invention, the fire protection system 100 may also include a third fastening mechanism (not shown) adapted to retain the cover member 102 in the folded position. For example, the third fastening mechanism may be a hook and loop arrangement, a rope arrangement, a clamp arrangement or any other suitable fastening mechanism known in the art that enables the cover member 102 to be retained in the folded position. The third fastening mechanism may be firmly received on the folded side cover portions 108 of the cover member 102 for retaining the side cover portions 108 in the rolled position.

The cover member 102 may be enabled to assume the unfolded position and the folded position by utilizing the operating mechanism. The operating mechanism may be configured at a suitable portion such as the roof, of the dwelling 300. Further, the operating mechanism may be manually or automatically actuated for enabling the cover member 102 to assume one of the folded position and the unfolded position.

The fire protection system, as described herein, is adapted to be used by dwellings of various sizes. More specifically, the cover member of the fire protection system may be configured in a multitude of sizes and shapes for being utilized on dwellings of various sizes. In an embodiment of the present invention, the cover member may be configured as a unitary piece, such as a unitary tent shaped cover member. In another embodiment of the present invention, a support mechanism may be utilized for configuring the fire protection system on the dwelling. The support mechanism may be any mechanical arrangement configured on a portion, such as the roof, of the dwelling for supporting the fire protection system thereon. The fire protection system, as disclosed herein, may be advantageously used to protect dwellings from fire, such as the forest fire in a cost effective and an efficient manner.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A fire protection system for a dwelling, the fire protection system comprising:
a cover member composed of a fire resistant material, the cover member adapted to assume a folded position and an unfolded position, wherein the cover member is capable of enclosing the dwelling in the unfolded position;
a first fastening mechanism configured on the cover member, the first fastening mechanism adapted to retain the cover member in the unfolded position; and
an operating mechanism configured on a portion of the dwelling, the operating mechanism adapted to enable the cover member to assume the folded position and the unfolded position.

2. The fire protection system of claim 1, wherein the cover member comprises
a central cover portion adapted to be received on a roof of the dwelling, and
a plurality of side cover portions extending from a periphery of the central cover portion, the plurality of side cover portions adapted to be received on sidewalls of the dwelling when the cover member assumes the unfolded position.

3. The fire protection system of claim 2 further comprising a second fastening mechanism adapted to couple adjacently positioned side cover portions of the plurality of side cover portions in the unfolded position of the cover member for enclosing the dwelling therebetween.

4. The fire protection system of claim 3, wherein the second fastening mechanism comprises a clamp arrangement.

5. The fire protection system of claim 1, wherein the first fastening mechanism comprises a grommet and a peg arrangement.

6. The fire protection system of claim 1 further comprising a third fastening mechanism adapted to retain the cover member in the folded position thereof.

7. The fire protection system of claim 6, wherein the third fastening mechanism comprises at least one of a hook and a loop arrangement, a rope arrangement and a clamp arrangement.
